(19) United States
(12) Patent Application Publication
(10) Pub. No.: US 2007/0296932 A1
(43) Pub. Date: Dec. 27, 2007

(54) Image Forming Apparatus and Image Forming Method

(75) Inventor: Shuichi SUZUKI, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/421,750

(22) Filed: Jun. 1, 2006

(51) Int. Cl. G03B 27/00

(52) U.S. Cl. 355/18

(57) ABSTRACT

An image forming apparatus includes an image data input unit configured to take in image data, an image data storing unit having a hard disk drive and a volatile memory for saving the image data inputted from the image data input unit, a mode selecting unit configured for a user to select one of a normal security mode and a high security mode as a security mode for the image data, and an image data output unit configured to output the image data saved in the image data storing unit, in a predetermined format. If the normal security mode is selected by the mode selecting unit, the image data is saved in the hard disk drive, and if the high security mode is selected, the image data is saved in the volatile memory.

### BACKGROUND OF THE INVENTION

1. Field of the Invention

This invention relates to an image forming apparatus such as a copy machine, printer, scanner, facsimile and multifunction peripheral having plural ones of their functions, and an image forming method in which a security level for image data is selected, thus executing a job.

2. Description of the Related Art

For example, in the case of producing a copy of a document by using a multifunction peripheral (MFP) as a copy machine, the document is first read by a scanner. Image data of the document is thus obtained. This image data is saved in a hard disk drive (HDD), which is a storage device. Next, this image data is read out from the HDD and formed again into an image, and the image is printed on a paper.

With such configuration, even if a print job is interrupted by a trouble such as paper jam, the document need not be scanned again after troubleshooting, and printing can be resumed by using the image data saved in the HDD. Also, sorting and a print job such as printing on plural papers or double-side printing can be performed smoothly.

When this print job is finished, the image data saved in the HDD is erased so that the image data no longer can be reproduced as an image.

Also a print job by a printer, a print job for received data by a facsimile and a data transmission job by a facsimile are similarly performed. For example, in a print job using an MFP as a printer, first, print data described in a page description language is sent from a personal computer or the like to the MFP. This print data is bit-map-converted for each page by a raster image processor (RIP) provided in the MFP. Page data is thus produced. This page data is temporarily saved in the HDD. Next, the page data is read out from the HDD and formed into an image, and the image is printed on a paper. Then, after this print job is finished, the page data saved in the HDD is erased so that this page data no longer can reproduced.

One method for erasing the image data saved in the HDD is to erase so-called FAT (File Allocation Table) information related to the image data. In this data erasing method, the image data itself is not erased. However, when the FAT information is erased, the location of the corresponding image data cannot be known and therefore the image data cannot be accessed. Thus, the image data is regarded as erased.

Also, JP-A-2005-202526 discloses a method of storing FAT information into a volatile memory. In this method, by erasing the FAT information stored in the volatile memory, it becomes difficult to access the image data saved in the HDD.

These data erasing methods are advantageous in that the load on a processor that performs operation control of the image forming apparatus and data processing can be reduced. However, in these data erasing methods, it is not impossible to reproduce the image data because the image data itself is not erased. Therefore, if a malicious third party acquires an HDD in which a document or the like of high secrecy has been saved as image data, the document can be restored.

As another data erasing method, there is known a method of overwriting the image data saved in the HDD with random data plural times and thus erasing the image data. The security level of this method is high. However, this method needs a long time for erasing data. Also, while data is being erased, for example, new jobs are restricted and therefore job performance is lowered. Moreover, since the number of accesses to the HDD increases, the service life of the HDD is reduced.

As another security measure for image data, a method of encrypting the image data is known. The encrypted image data is saved in the HDD. The image data saved in the HDD is taken out and decoded. The image data is thus reproduced. In this method, restoration of the image data is difficult unless the encryption algorithm is decrypted. Therefore, the security level of this method is high. However, in this method, job performance is lowered by performing the data processing of encryption/decoding.

In this manner, in the conventional MFP, uniform security is provided for the image data. However, not all the documents or the like handled in the image forming apparatus are confidential. That is, in many cases, there is no problem if image data remains in the HDD. Thus, it is preferable to provide a configuration for performing simple erasure processing of image data of low-confidentiality documents or the like and enabling prevention of leakage of image data of documents or the like that requires high confidentiality. It is because this configuration can enhance cost performance and job performance.

### SUMMARY OF THE INVENTION

It is an object of this invention to provide an image forming apparatus and an image forming method that realize prevention of data leakage at a higher security level with respect to image data of a highly confidential document or the like.

According to a first aspect of this invention, there is provided an image forming apparatus including an image data input unit configured to take in image data, an image data storing unit having a hard disk drive and a volatile memory for saving the image data inputted from the image data input unit, a mode selecting unit configured for a user to select one of a normal security mode for saving the image data to the hard disk drive and a high security mode for saving the image data to the volatile memory as a security mode for image data, and an image data output unit configured to output the image data saved in the image data storing unit, in a predetermined format.

According to a second aspect of this invention, there is provided an image forming apparatus including image data input means for taking in image data, image data storing means having non-volatile memory means and volatile memory means for saving the image data inputted from the image data input means, mode selecting means for a user to select one of a normal security mode for saving the image data to the non-volatile memory means and a high security mode for saving the image data to the volatile memory means as a security mode for image data, and image data output means for outputting the image data saved in the image data storing means, in a predetermined format.

According to a third aspect of this invention, there is provided an image forming method for an image forming apparatus that takes in image data and outputs the image data in a predetermined format, the method including: selecting either a normal security mode for saving the image data to a hard disk drive or a high security mode for saving the image data to a volatile memory, as a security mode for image data to be taken in; taking in image data; saving the taken-in image data to either the hard disk drive or the volatile memory in accordance with the selected security mode; and reading out the image data saved in either the hard disk drive or the volatile memory and outputting the image data in a predetermined format.

According to the image forming apparatus and the image forming method of this invention, in a job that handles a highly confidential document, chart or the like, leakage of image data of such a document or the like can be securely prevented by using the high security mode.

### BRIEF DESCRIPTION OF THE DRAWINGS

FIG. 1 is a view showing a system configuration of an image forming apparatus according to one embodiment of this invention;

FIG. 2 is an operation flowchart in the case of performing a copy job using the image forming apparatus;

FIG. 3 is a flowchart showing further details of the processing of ST8 to ST10 in FIG. 2;

FIG. 4 is a flowchart of image data processing from ST201 to ST202 in FIG. 3; and

FIG. 5 is a flowchart showing the details of the processing of page data for a printer unit provided in the image forming apparatus to perform image printing on a paper.

### DETAILED DESCRIPTION OF THE PREFERRED EMBODIMENTS

Hereinafter, an embodiment of the invention will be described in detail with reference to the drawings.

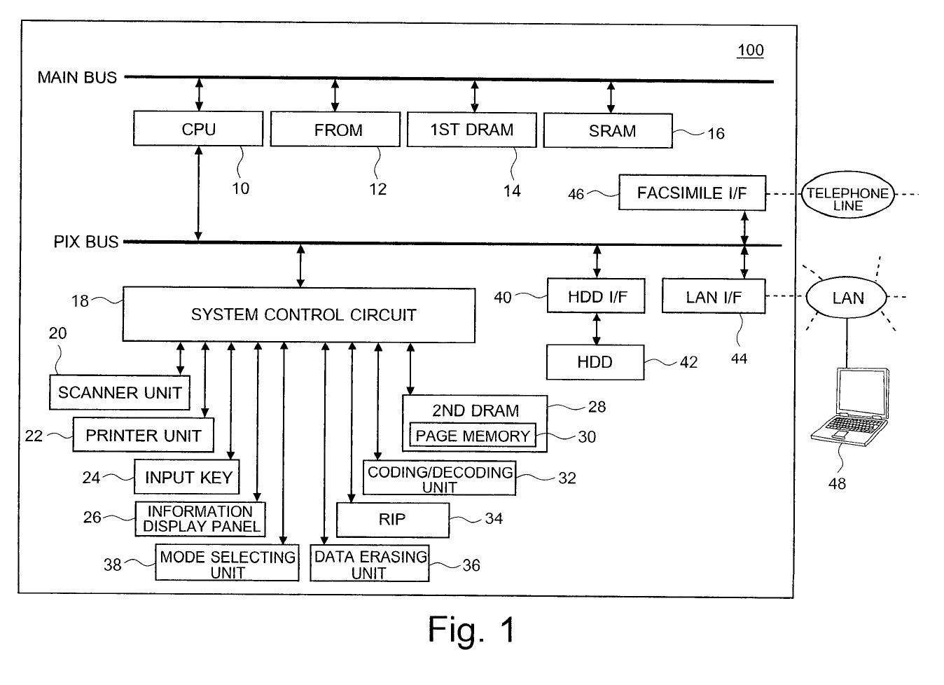

FIG. 1 shows a system configuration of an image forming apparatus according to an embodiment of this invention. This image forming apparatus 100 is a multifunction peripheral (MFP) and has the functions of a copier, printer, scanner and facsimile.

The image forming apparatus 100 has a central processing unit (CPU) 10 that takes charge of operation control of the image forming apparatus 100 and data processing, a flash ROM (FROM; Flash Read Only Memory) 12 in which programs for operation control of the image forming apparatus 100 and data processing are stored, a first volatile memory (DRAM; Dynamic Random Access Memory) 14 for temporarily storing control information and the like related to jobs to be executed in the image forming apparatus 100, and a non-volatile memory (SRAM; Static Random Access Memory) 16 mainly for saving the setting information of the image forming apparatus 100. These CPU 10, FROM 12, first DRAM 14 and SRAM 16 are connected to a main bus that mainly transmits signals for performing operation control of the image forming apparatus 100.

The CPU 10 is also connected to a PIX bus for mainly transmitting image data in the image forming apparatus 100. To this PIX bus, a system control circuit 18 is connected which controls the parts that perform intake, processing and saving of image data, and also performs processing of image data.

A scanner unit 20, a printer unit 22, an input key 24, an information display panel 26, a second DRAM 28, a coding/decoding unit 32, a RIP 34, a data erasing unit 36 and a mode selecting unit 38, which will be described later, are connected to the system control circuit 18. The system control circuit 18 supervises controls related to image data processing such as communication control between these units, control of image data compression/decompression processing, page memory control, and control of an LCD controller.

A facsimile interface 46 for performing control of line connection in conformity with the line standard of each country and control of G3 facsimile communication prescribed by the ITU recommendations, and a LAN interface 44 for performing data communication between the image forming apparatus 100 and a personal computer (PC) 48 that is LAN-connected to the image forming apparatus 100 are connected to the PIX bus.

The facsimile interface 46 has a connector and a circuit for telephone line connection, a modem circuit for communication control, and a facsimile control circuit and a CPU for controlling these. The LAN interface 44 enables various network communications such as network printing and network scan in accordance with the control of the network protocols such as TCP/IP, IPX/SPX and AppleTalk.

The image forming apparatus 100 has a hard disk drive (HDD) 42 for saving image data, and an HDD interface 40 for writing and reading image data to and from this HDD 42. Also the HDD interface 40 is connected to the PIX bus.

The image forming apparatus 100 has the scanner unit 20 for reading a document, the printer unit 22 that forms image on a paper on the basis of image data, the input key 24 having various keys (buttons) for operating the image forming apparatus 100, the information display panel 26 for displaying operation information according to the operation of the input key 24 and job information that is currently being performed, and the second DRAM 28 for temporarily saving image data.

The scanner unit 20 has a line sensor that cast light onto a document set on a document table or a document automatically fed by ADF and photoelectrically converts the reflected light, a driving device for driving the line sensor, a paper size sensor for detecting the document size, and a CPU that controls these.

The printer unit 22 has a device that transports a paper, a photoconductive drum, a charging device, a developing device, a transfer device, a fixing device, and a CPU that controls these. The input key 24 has various operation keys such as start key, pause key, numeric key and job selection key. The information display panel 26 is, for example, a liquid crystal panel. A job condition set by operating the input key 24 is displayed on the information display panel 26. The information display panel 26 has a touch panel function. A user can select a desired operation by selecting an operation icon displayed on the information display panel 26. A part of the storage area of the second DRAM 28 is a page memory 30. For example, image data read by the scanner unit 20 is saved as page data into the page memory. In the other parts of the storage area of the second DRAM 28, for example, compressed page data is stored.

The image forming apparatus 100 also has the coding/decoding unit 32 that converts image data to coded data at the time of facsimile transmission and that decodes coded data received through facsimile to image data, the raster image processor (RIP) 34 for converting print data transmitted from the PC 48 to image data, the data erasing unit 36 for erasing image data saved in the HDD 42, and the mode selecting unit 38 for selecting a security mode for image data. Each of the coding/decoding unit 32, the data erasing unit 36 and the mode selecting unit 38 may be an arrangement having a dedicated program, memory and CPU. Alternatively, their functions may be realized by starting the programs saved in the FROM 12.

The mode selecting unit 38 causes the information display panel 26 to display the two security modes that can be selected by the user. One security mode is called “normal mode” and the other is called “high security mode”. The default setting is “normal mode”.

The processing of image data in the normal mode will be described with respect to a copy job as an example. In the normal mode, image data read by the scanner unit 20 is stored as page data into the page memory 30. Next, the page data is read out from the page memory 30 and compressed by a predetermined method. The compressed page data is saved in the HDD 42. Then, the compressed page data is read out from the HDD 42 and the compressed page data is decompressed. This restores the page data. This page data is sent to the printer unit 22. In the printer unit 22, the page data is formed into an image and the image is printed on a paper.

When the print processing is finished normally, the FAT information of the compressed page data saved in the HDD 42 is erased. The page data itself remains saved in the HDD 42, but the erasure of the FAT information makes it difficult to access the image data.

The processing of image data in the high security mode will be described with respect to a copy job as an example. Image data read by the scanner unit 20 is stored as page data into the page memory 30. Next, the page data is read out from the page memory 30 and compressed by a predetermined method. The compressed page data is stored into a storage area of the second DRAM 28 other than the page memory 30. Then, the compressed page data is read out from the second DRAM 28 and the compressed page data is decompressed. This restores the page data. This page data is sent to the printer unit 22. In the printer unit 22, the page data is formed into an image and the image is printed on a paper.

In the high security mode, the page data stored in the second DRAM 28 vanishes when the power of the image forming apparatus 100 is turned off. If the second DRAM 28 is removed from the image forming apparatus 100, the page data stored in the page memory vanishes through this action. Thus, the page data stored in the second DRAM 28 cannot be retrieved. In this manner, in the high security mode, leakage of image data is prevented by not saving the image data in the HDD 42.

The image forming apparatus 100 has a configuration such that page data will not be left in the page memory 30 when the page data is read out from the page memory 30. The purpose of storing again the page data stored in the page memory 30 into the second DRAM 28 is to enable smooth restart of printing based on the page data stored in the second DRAM 28 even when trouble such as paper jam occurs at the time of printing on a paper.

If the HDD 42 and the second DRAM 28 have the same storage capacity, the HDD 42 is much less expensive than the second DRAM 28. Therefore, by providing a configuration to distinguish the HDD 42 and the second DRAM 28 in accordance with the degree of confidentiality of image data to be handled, the storage capacity of the second DRAM 28 can be minimized. Thus, the cost performance of the image forming apparatus 100 can be increased.

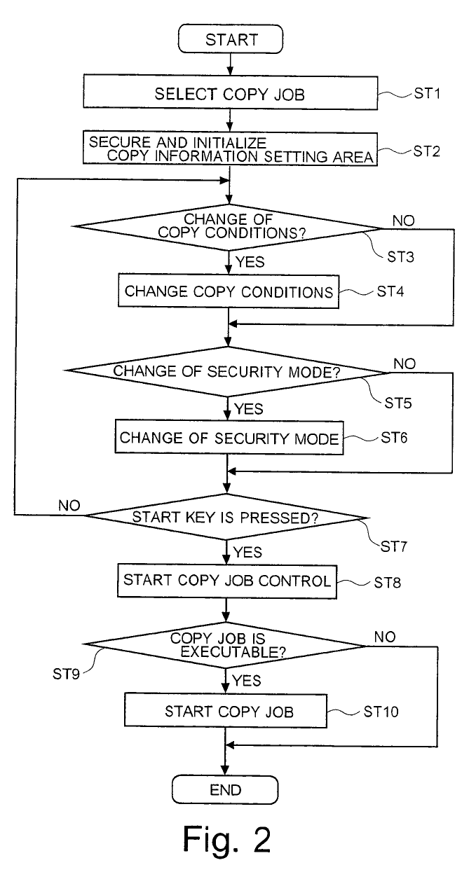

Next, an image processing flow in the image forming apparatus 100 will be described with respect to the case of performing a copy job as an example. FIG. 2 shows a flowchart for the operations in the case of performing a copy job using the image forming apparatus 100. The user operates the input key 24 or the information display panel 26 to select a copy job as a job to be executed (ST1). As a copy job is selected, necessary information for its execution (hereinafter referred to as “job conditions”) is initialized, and an area for setting these job conditions (hereinafter referred to as “information setting area”) is secured in the first DRAM 14 and this information setting area is initialized (ST2). These initialized job conditions are, for example, normal mode as the security mode, 1 as the number of copies, printing from one side of a document to one side of a paper, automatic selection of paper size, and the like.

When the user wants to execute a copy job under different conditions from these initialized job conditions, the user can operate the input key 24 and the information display panel 26 to change the job conditions. Therefore, after ST2, it is judged whether the job conditions are changed or not (ST3). If it is judged at ST3 that the user changed the job conditions, the new job conditions are set in the information setting area (ST4). An exemplary change of the job conditions may be, for example, changing the number of copies to 10, setting the paper feed tray to a manual insertion tray, executing enlarged copy, performing double-side printing, or the like. If it is judged at ST3 that the copy conditions are not changed, the processing goes to ST5, which will now be described.

When changing the setting of the copy conditions, the user can operate the information display panel 26 to change the security mode. Therefore, after ST4, it is judged whether there is a change of the security mode or not (ST5). As described above, in the initial conditions, the security mode is set to the normal mode. Therefore, if the user selects the high security mode, the security mode is changed to the high security mode (ST6). If the security mode is not changed, the processing is in a standby state for input of copy job start. Either ST3, ST4 or ST5, ST6 may be performed first.

When ST6 ends, a copy job can be started. It is judged whether the user pressed a start key or not (ST7). If the start key is pressed, copy job control is started (ST8). This start of copy job control means start of a control program for checking whether a copy job according to the preset copy conditions is actually executable or not.

When copy job control is started at ST8, it is checked whether necessary resources for executing a copy job according to the preset copy conditions (that is, the constituent parts of the image forming apparatus 100) are operable or not (ST9). If there is no anomaly in the resources at ST9, actual operation of the copy job is started (ST10). On the other hand, if there is anomaly in the resources at ST9, the copy job is suspended.

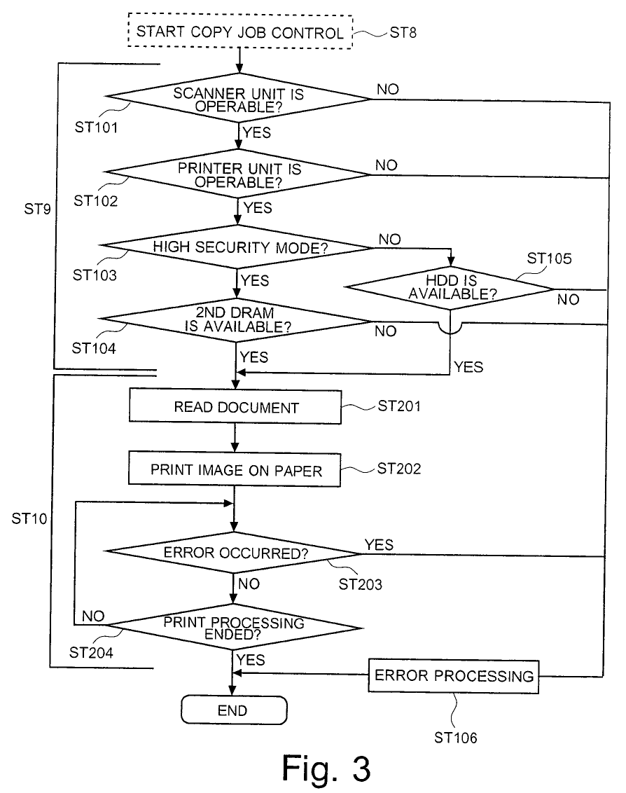

Now, the processing of ST8 to ST10 will be described further in detail. FIG. 3 is a flowchart showing further details of the processing of ST8 to ST10. The resources for executing a copy job include the scanner unit 20, the printer unit 22, the second DRAM 28 and the HDD 42.

When copy job control is started, first, it is checked whether the scanner unit 20 is operable or not (ST101). If the scanner unit 20 is operable, it is then checked whether the printer unit 22 is operable or not (ST102). If the printer unit 22 is operable, it is checked whether a storage device used for saving page data in accordance with a preset security mode (hereinafter referred to as “page data saving device”) is available or not (ST103) If the security mode has been set to the high security mode, it is checked whether the second DRAM 28 is available or not, which is one of the page data saving devices (ST104). If the security mode has been set to the normal mode, it is checked whether the HDD 42 is available or not, which is one of the page data saving devices (ST105). These ST101 to 105 represent the specific processing of ST9.

If at least one of the scanner unit 20 and the printer unit 22 is unavailable as a result of the check at ST101 and 102, error processing (ST106) is performed. Also, if the page data saving device checked in accordance with the security mode is unavailable as a result of the check at ST104 and 105, error processing (ST106) is performed. In these cases, the copy job is suspended. When the copy job is suspended, an unavailable resource and its reason (error mode) are displayed on the information display panel 26. The user understands this error mode and examines the image forming apparatus 100 so that the error will be solved.

If it is judged at ST104 that the second DRAM 28 is available but has an insufficient storage capacity, it is determined that the second DRAM 28 is unavailable. As a method for dealing with such a circumstance, means for erasing image data stored in the second DRAM 28 may be provided.

If predetermined resources are available as a result of the judgment at ST101, 102, 104 and 105, the copy job is started (ST10). First, a document is read by the scanner unit 20 (ST201). The image read by the scanner unit 20 is printed onto a paper by the printer unit 22 (ST202). The data processing between ST201 and 202 will be later described in detail. During the processing of ST201 and 202, whether an error occurred or not is constantly monitored (ST203), and whether the print processing ended or not is monitored, too (ST204). For example, exemplary errors include document paper jam, print paper jam and the like.

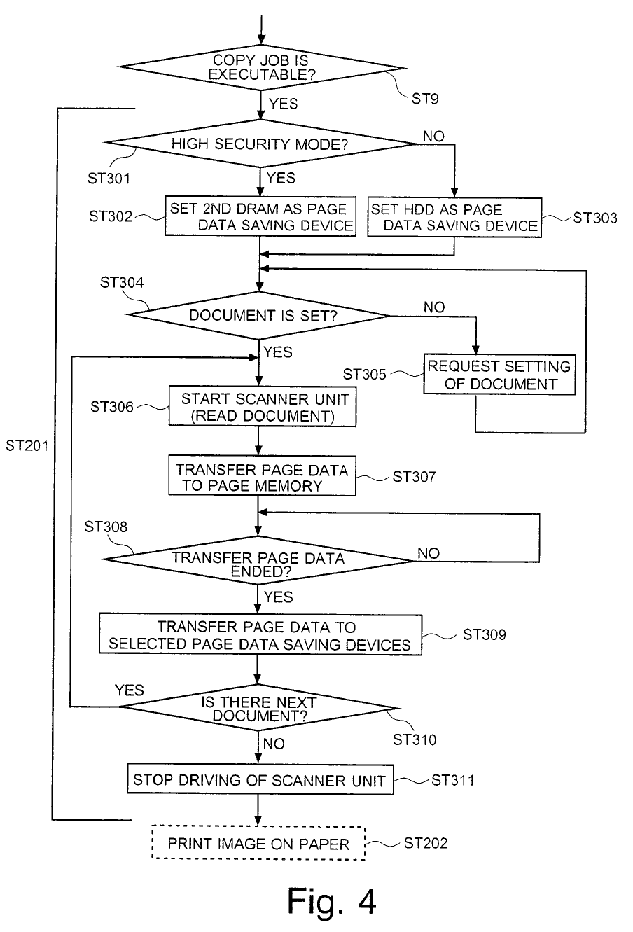

FIG. 4 shows a more detailed flowchart of the image data processing from the reading of a document (ST201) to the printing to a paper (ST202). First, the security mode that has been set is confirmed (ST301). If the security mode has been set to the high security mode, the second DRAM 28 is set as the page data saving device (ST302). On the other hand, if the security mode is has been set to the normal mode, the HDD 42 is set as the page data saving device (ST303).

It is judged whether the document has been placed on the document tray or ADF (S304). If the document has not been set, a message that requests the user to set the document at a predetermined position is displayed on the information display panel 26 (ST305). On the other hand, if the document has been set at a predetermined position, the scanner unit 20 starts reading the first page of the document (ST306). The image data read by the scanner unit 20 is transferred to and saved in the page memory 30 secured in the second DRAM 28, as page data for each page of the document (ST307).

It is judged for each page data whether the transfer of page data of one page to the page memory 30 ended or not (ST308). This judgment at ST308 is “NO” until the transfer of page data of one page to the page memory 30 ends. When the transfer of page data of one page to the page memory 30 ends, the judgment at ST308 becomes “YES”.

When the judgment at ST308 is “YES”, the page data stored in the page memory 30 is read out. This page data is compressed by a predetermined data compressing method and then transferred to and saved in the page data saving device in accordance with the preset security mode (ST309). Then, the presence/absence of the next document is judged (ST310). If the next document has been set as in the case where the document includes plural pages, the judgment at ST310 is “YES” and consequently the processing of ST306 to 309 is repeated. On the other hand, if the next document has not been set, the judgment at ST310 is “NO” and the driving of the scanner unit 20 is stopped (ST311).

After the page data is transferred to the page data saving device, printing on a paper is started (ST202). If the document includes plural pages, this processing of ST202 may be started for all the page data immediately after all the page data are transferred to the page data saving device. Meanwhile, the processing of ST202 may be started immediately after page data of one page is transferred to the page data saving device. If the document includes plural pages, the processing of ST202 can be started before the driving of the scanner unit 20 is stopped.

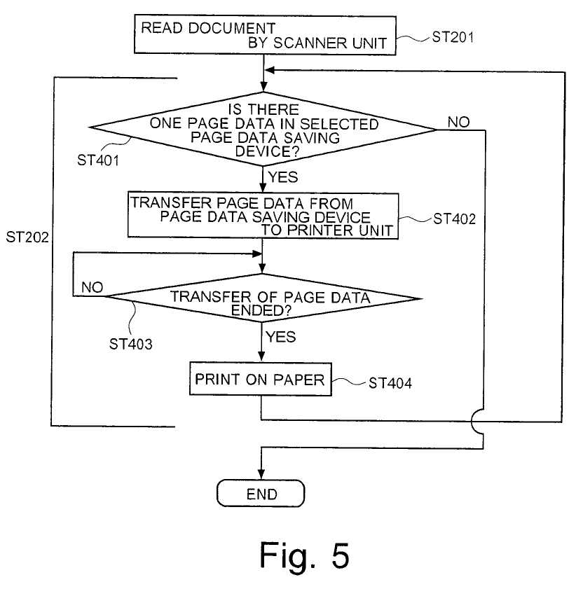

FIG. 5 is a flowchart showing the details of the page data processing flow when image printing on a paper is performed by the printer unit 22. The system control circuit 18 checks whether the compressed page data has been saved in the page data saving device corresponding to the preset security mode (ST401). If, as a result, there is page data of at least one page, the page data is read out from the page data saving device, decompressed by the system control circuit 18, and transferred to the printer unit 22 (ST402).

The printer unit 22 judges whether the transfer of this page data ended or not (ST403). As the transfer of the page data of one page ends, the page data is formed into an image and the image is printed onto a paper (ST404). When this printing on the paper ends, the processing returns to the judgment at ST401. If the judgment at ST401 is “NO”, it indicates that page data to be printed has not been saved in the page data saving device. Thus, the print job ends.

Next, the image data processing flow in the case of performing facsimile transmission by using the image forming apparatus 100 will be briefly described. The input key 24 and the information display panel 26 are operated to designate a facsimile transmission job. Also, a security mode is selected. Then, the image data of all the transmitting document is read by the scanner unit 20 and the page data is stored into the page data saving device corresponding to the selected security mode. After that, a dial-up operation is made to the destination of data transmission. As the line is opened, the page data is read out from the page data saving device and coded by the coding/decoding unit 32. The data thus coded is transmitted to the destination through the facsimile interface 46.

As for facsimile reception, when to receive facsimile data is generally unknown. Therefore, in consideration of enhanced security against leakage of received data, it is preferable to set the high security mode as default setting in the facsimile reception. Alternatively, the normal mode may be set as default setting of the security mode, and when receiving facsimile data from a specific facsimile number, the security mode can be automatically switched to the high security mode by recognizing the facsimile number of the source. Such setting can also be applied to the case of facsimile transmission job.

In the case where the image forming apparatus 100 is used as a printer for the PC 48, it is preferable to enable selection of a security mode at the PC 48 by utilizing bidirectional communication between the image forming apparatus 100 and the PC 48 and a printer browser installed in the PC 48. Print data sent from the PC 48 to the image forming apparatus 100 is converted to page data by the RIP 34. The page data is stored temporarily in the page memory 30. The subsequent processing flow for page data is similar to the above-described case of copy job.

The embodiments of this invention have been described above. However, this invention is not limited to these embodiments. Various variations, modifications and substitutions can be made by those skilled in the art without departing from the scope of the invention as defined by the claims. It should be understood that those variations, modification and substitutions are included in the scope of this invention.

For example, in the high security mode, the page data stored in the page memory 30 of the second DRAM 28 may be erased immediately after the output of the page data ends normally. For example, as a method for erasing the page data stored in the second DRAM 28, a power supply stop circuit that temporarily stops power supply to the second DRAM 28 may be provided and the operation of this power supply stop circuit may be carried out by the data erasing unit 36. This power supply stop circuit can be formed by a switch that turns on and off the power supply to the second DRAM 28, and a switch control circuit that operates this switch to turn on and off. Thus, the storage capacity of the second DRAM 28 can be secured and occurrence of errors due to insufficient capacity of the second DRAM 28 can be reduced.

In the high security mode of the above-described image forming apparatus 100, for example, the page data read out from the page memory 30 may be sent to the printer unit 22 and printing on a paper may be performed there. That is, a configuration without using the second DRAM 28 can be used. In this case, however, if trouble occurs at the time of printing on a paper, the document must be read again.

Also, as a modification of the above-described image forming apparatus 100, a configuration having a non-volatile memory such as flash memory instead of the second DRAM 28 may be employed. However, if a flash memory is used, image data saved in the flash memory will not be erased even when power supply to the flash memory is stopped. Therefore, the system configuration of the image forming apparatus must be made such that the image data saved in the flash memory is mandatorily erased after the end of a job. The non-volatile memory such as flash memory can be used instead of the HDD 42.

What is claimed is:

1. An image forming apparatus comprising:
an image data input unit configured to take in image data;
an image data storing unit having a hard disk drive and a volatile memory for saving the image data inputted from the image data input unit;
a mode selecting unit configured for a user to select one of a normal security mode for saving the image data to the hard disk drive and a high security mode for saving the image data to the volatile memory as a security mode for the image data; and
an image data output unit configured to output the image data saved in the image data storing unit, in a predetermined format.

2. The image forming apparatus according to claim 1, further comprising a display unit having a touch panel function for setting a job that is to be executed, and configured to display type, condition, and status of operation of a job that has been set,
wherein the mode selecting unit causes the display unit to display an icon for selecting either the normal security mode or the high security mode.

3. The image forming apparatus according to claim 2, wherein the display unit is a liquid crystal display.

4. The image forming apparatus according to claim 1, further comprising a data erasing unit configured to erase FAT information of image data saved in the hard disk drive after completion of output of the image data by the image data output unit.

5. The image forming apparatus according to claim 1, further comprising a power supply stop unit configured to temporarily stop power supply to the volatile memory.

6. The image forming apparatus according to claim 5, wherein the power supply stop unit includes a switch that turns on and off power supply to the volatile memory and a switch control circuit that operates the switch to turn on and off.

7. The image forming apparatus according to claim 1, wherein the image data input unit is a scanner unit that reads an image expressed on a document by using a photoelectric converter device, and
the image data output unit is a printer unit that prints the image read by the scanner unit onto a paper.

8. The image forming apparatus according to claim 1, wherein the image data input unit is a scanner unit that reads an image expressed on a document by using a photoelectric converter device, and
the image data output unit is a facsimile interface that transmits the image data read by the scanner unit to outside as facsimile data.

9. The image forming apparatus according to claim 1, wherein the image data input unit is a scanner unit that reads an image expressed on a document by using a photoelectric converter device, and
the image data output unit is a LAN interface for transmitting the image data read by the scanner unit to an external terminal.

10. The image forming apparatus according to claim 1, wherein the image data input unit is a facsimile interface that receives facsimile data transmitted from outside through a telephone line, and
the image data output unit is a printer unit that forms the image data received by the facsimile interface into an image and prints the image on a paper.

11. The image forming apparatus according to claim 1, wherein the image data input unit is a LAN interface that receives image data transmitted from an external terminal through a LAN line, and
the image data output unit is a printer unit that forms the image data received by the LAN interface into an image and prints the image on a paper.

12. The image forming apparatus according to claim 1, wherein the volatile memory is a DRAM.

13. An image forming apparatus comprising:
image data input means for taking in image data;
image data storing means having non-volatile memory means and volatile memory means for saving the image data inputted from the image data input means;
mode selecting means for a user to select one of a normal security mode for saving the image data to the non-volatile memory means and a high security mode for saving the image data to the volatile memory means as a security mode for the image data; and
image data output means for outputting the image data saved in the image data storing means, in a predetermined format.

14. An image forming method for an image forming apparatus that takes in image data and outputs the image data in a predetermined format, the method comprising:
selecting either a normal security mode for saving the image data to a hard disk drive or a high security mode for saving the image data to a volatile memory, as a security mode for image data to be taken in;
taking in image data;
saving the taken-in image data to either the hard disk drive or the volatile memory in accordance with the selected security mode; and
reading out the image data saved in either the hard disk drive or the volatile memory and outputting the image data in a predetermined format.

15. The image forming method according to claim 14, wherein the intake of the image data is carried out by reading an image expressed on a document by using a photoelectric converter device, and the output of the image data is carried out by forming the image data into an image and printing the image on a paper.

16. The image forming method according to claim 14, wherein the intake of the image data is carried out by reading an image expressed on a document by using a photoelectric converter device, and the output of the image data is carried out by transmitting the image data to outside as facsimile data.

17. The image forming method according to claim 14, wherein the intake of the image data is carried out by reading an image expressed on a document by using a photoelectric converter device, and the output of the image data is carried out by transmitting the image data to an external terminal via LAN.

18. The image forming apparatus according to claim 14, wherein the intake of the image data is carried out by receiving facsimile data transmitted from outside through a telephone line, and the output of the image data is carried out by forming the image data into an image and printing the image on a paper.

19. The image forming apparatus according to claim 14, wherein the intake of the image data is carried out by receiving image data transmitted from an external terminal via LAN, and the output of the image data is carried out by forming the image data into an image and printing the image on a paper.
